(19) United States
(12) Patent Application Publication
(10) Pub. No.: US 2010/0116106 A1
(43) Pub. Date: May 13, 2010

(54) CUTTING DEVICE

(76) Inventor: Thomas Baur, Hilchenbach (DE)

Correspondence Address: FRIEDRICH KUEFFNER, 317 MADISON AVENUE, SUITE 910, NEW YORK, NY, 10017, US

(21) Appl. No.: 12/451,027

(22) PCT Filed: Apr. 7, 2008
(86) PCT No.: PCT/EP2008/002730

§ 371 Date: Oct. 23, 2009

(30) Foreign Application Priority Data
Apr. 27, 2007 (DE) 102007019963.7

(51) Int. Cl. B26D 1/00; B26D 5/08

(52) U.S. Cl. 83/13; 83/618

(57) ABSTRACT

The invention relates to a cutting device (1) with a first cutting blade (2) of an upper cutter and a second cutting blade (3) of a lower cutter, with a drive device with at least two rotatably driveable eccentric shafts (10, 11), which are connected at least to the first cutting blade by means of connecting elements (8, 9), wherein at least one of the connecting elements (8, 9) is formed such that it is variably adjustable in length.

### TECHNICAL FIELD

The invention concerns a cutting device, especially for cutting sheet, in accordance with the introductory clause of Claim 1. The invention also concerns a method for cutting sheet in accordance with the introductory clause of Claim 8.

### PRIOR ART

Cutting devices for cutting sheet are well known in the prior art. In this regard, cutting devices are known that have cutting blades that can be displaced relative to each other in a rotating motion by means of a driven movement.

DE 23 45 596 A discloses a cutting device in which a cutting operation can be carried out by means of a first cutting blade and by means of a second cutting blade. The second cutting blade in this cutting device is provided with a device for moving back and forth, so that the second cutting blade with its cutting edge can be moved in the cutting plane. To this end, the cutting blade is movably supported and driven by means of connecting links and joints.

DE 27 46 402 A likewise discloses a cutting device in which a cutting operation can be carried out by means of a first cutting blade and by means of a second cutting blade, wherein the second cutting blade is also provided with a device for moving back and forth, so that the second cutting blade with its cutting edge can be moved in the cutting plane. To this end, the cutting blade in this case is also movably supported by means of connecting links and joints. Comparable devices are disclosed by DE 21 22 855 A and DE 17 77 014 A.

DE 25 10 881 discloses a cutting device in which a cutting blade is articulated on cam followers by levers, and the cutting blade can be moved by the rotation of the cam followers. DE 23 29 096 A discloses a comparable articulation of a cutting blade by cam followers.

In these cutting devices, the guidance of the cutting blade by the articulations is predetermined in a fixed way by means of the levers and the cam followers, so that varying cut geometries are not possible, and therefore different sheet thicknesses cannot be processed or cannot be optimally processed with one cutting device.

### DESCRIPTION OF THE INVENTION, OBJECTIVE, ACHIEVEMENT OF THE OBJECTIVE, ADVANTAGES

The objective of the invention is to create a cutting device and a method by means of which it is possible to realize a variable cut geometry, so that sheets of varying thickness can be processed.

In accordance with the invention, the objective with respect to the device is achieved with the features of Claim 1. The objective with respect to the method is achieved with the features of Claim 8.

In accordance with the invention, for this purpose, the cutting device is provided with a first cutting blade of an upper cutter and a second cutting blade of a lower cutter and with a drive device that has at least two rotatably drivable eccentric shafts, which are connected at least with the first cutting blade by means of connecting elements, wherein at least one of the connecting elements is designed to be variably adjustable in its length.

In this regard, in accordance with the invention, it is advantageous if both of the connecting elements between the eccentric shafts and the first cutting blade can be variably adjusted in length.

In accordance with the invention, it is also advantageous if the at least one connecting element that can be variably adjusted in its length has an adjusting element for making this length adjustment of the connecting element.

In an advantageous embodiment, it is effective if the adjusting element has a threaded rod or threaded spindle and at least one or preferably two threaded sleeves. In this regard, the threaded rod or threaded spindle and the threaded sleeve can be rotated relative to each other, so that the result is a variation of the length of the connecting elements. The adjustment can be controlled mechanically or electronically, for example, by means of an electric motor or a hydraulic or pneumatic motor.

In another advantageous embodiment, it is effective if the adjusting element has a piston-cylinder unit with a piston and a cylinder. It is advantageous if the piston-cylinder unit can be acted upon by a pressure medium, so that the action of a pressure medium, such as hydraulic oil, air, etc., makes it possible to carry out the adjustment of the piston-cylinder unit relative to each other and thus makes it possible to carry out the variation of the length.

In another advantageous embodiment, it is effective if the adjusting element has an eccentrically adjustable articulation on the eccentric shaft.

In this regard, it is advantageous if the eccentrically adjustable articulation on the eccentric shaft has an adjustable ring or region, which has a rotatably variable articulation of the connecting element on the eccentric shaft. The point of rotation of the connecting element in the area of the eccentric shaft can be adjusted by the rotation of the articulation, so that it can be adjusted closer or farther from the axis of rotation of the eccentric shaft.

The objective with respect to the method is achieved with a method for controlling a cutting device with a first cutting blade of an upper cutter and a second cutting blade of a lower cutter and with a drive device that has at least two rotatably drivable eccentric shafts, which can be connected at least with the first cutting blade by means of connecting elements, wherein at least one of the connecting elements can be variably adjusted in its length.

In this regard, it is effective if both connecting elements can be variably adjusted in length independently of each other.

Advantageous modifications are described in the dependent claims.

### BRIEF DESCRIPTION OF THE DRAWINGS

The invention is explained in greater detail below with reference to the embodiment illustrated in the drawings.

FIG. 1 is a schematic representation of a cutting device of the invention.

FIG. 2 is a schematic representation of a cutting device of the invention.

FIG. 3 is a schematic representation of a cutting device of the invention.

FIG. 4 is a schematic representation of a cutting device of the invention.

FIG. 5 is a schematic representation of a cutting device of the invention.

FIG. 6 is a schematic representation of a cutting device of the invention.

### PREFERRED EMBODIMENT OF THE INVENTION

FIG. 1 is a schematic representation of a cutting device of the invention. The cutting device 1 has a first cutting blade 2 and a second cutting blade 3. Each of the two cutting blades 2, 3 has a cutter 4, 5, which is connected with a blade carrier 6, 7 of the cutting blade 2, 3. The first cutting blade 2 forms part of an upper cutter, and the second cutting blade 3 forms part of a lower blade. To carry out the cutting operation, the cutting blade 2 is connected with eccentric shafts 10, 11 by connecting elements 8, 9, so that rotation of the eccentric shafts 10, 11 in the direction indicated by the arrows causes the cutting blade 2 to move. The motion of the first cutting blade 2 is a result of superimposed linear and rotational motions. The second cutting blade 3 is preferably immovably fixed, but in another embodiment, it can also be designed to be movable by the action of eccentric shafts.

The eccentric shafts 10, 11 are each supported in such a way that they are able to rotate about their axes 12, 13, and the connecting elements 8, 9 are pivoted eccentrically with respect to the axes of rotation 12, 13 of the eccentric shafts, so that the connecting elements 8, 9 are displaced by the rotation of the eccentric shafts 10, 11, and the cutting blade 2 is correspondingly moved due to the articulation of the connecting elements 8, 9 on the eccentric shafts 10, 11 and on the first cutting blade 2. A drive device (not shown) is provided for driving and rotating the eccentric shafts.

In accordance with the invention, the connecting elements 8, 9, which can also be designed as connecting rods, have adjusting elements 14, 15, 16, by which the length of the connecting elements 8, 9 can be varied and adjusted. The adjustable variation of the length of the connecting elements 8, 9 makes it possible to vary the cutter or the cutting blade 2 of the upper cutter carrier in its overlap and cutting motion. This adjustability and variability of the overlap makes it possible to improve the cut edges. When sheets of relatively great thickness are being cut, lesser sheet deformation at the cut edges can be realized. It is also possible to avoid shear bends and edge bending of the end of the sheet in the case of sheets of relatively great thickness.

The adjustment of the length of the connecting element 10, 11 makes it possible to reach the height of the first cutting blade, such as the upper cutter, and the depth of insertion of the cutter can thus be improved. Unequal adjustment of the length of the connecting elements 8, 9 relative to each other makes it possible to vary the movement of the first cutting blade in such a way that the course of the cut and the cutting angle can be varied. This makes it possible to make adaptations to different sheet thicknesses and material qualities, and it is preferably also possible to cut sheets with relatively large thicknesses with a rolling cut.

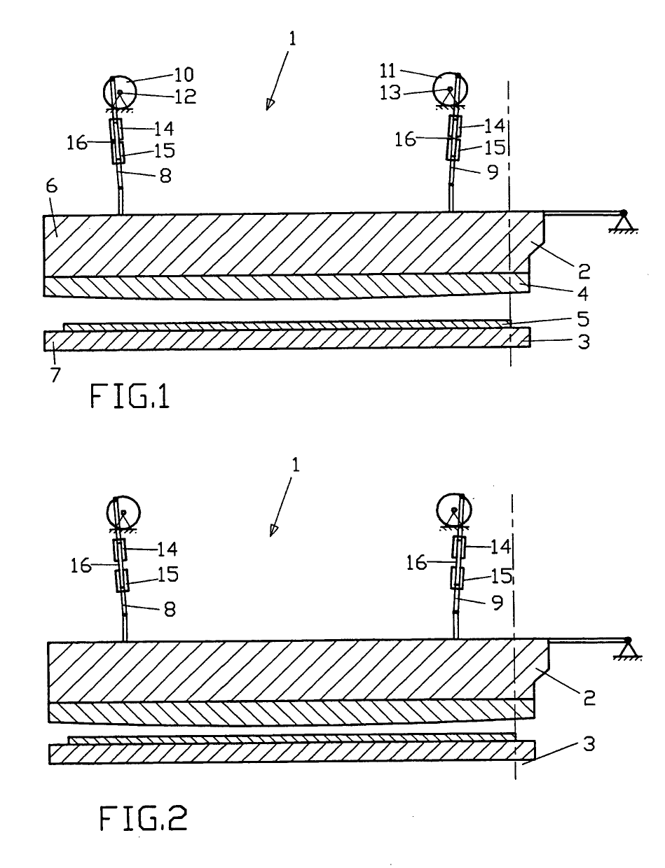

In the specific embodiment of FIGS. 1 and 2, the adjusting elements are formed by a threaded rod or threaded spindle 16 and by threaded sleeves 14, 15 that are connected with the threaded rod 16. The connecting elements 8, 9 can be lengthened or shortened by turning the threaded rod 16 or threaded spindle relative to the threaded sleeves 14, 15.

FIG. 1 shows an adjustment of the adjusting elements 14, 15, 16, in which the distance between the first cutting blade 2 and the second cutting blade 3 is relatively large. The threaded rod 16 or threaded spindle is retracted relative to the threaded sleeves 14, 15, so that a shortening of the connecting elements 8, 9 is realized.

FIG. 2 shows an adjustment of the adjusting elements 14, 15, 16, in which the distance between the first cutting blade 2 and the second cutting blade 3 is relatively small compared to the adjustment shown in FIG. 1. The threaded rod 16 or threaded spindle is extended relative to the threaded sleeves 14, 15, so that a lengthening of the connecting elements 8, 9 is realized.

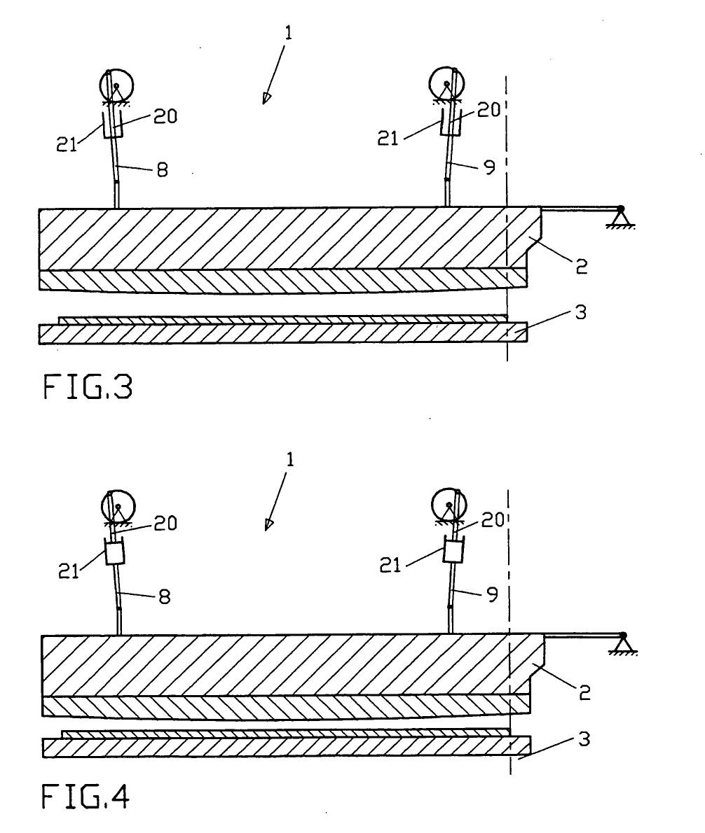

FIGS. 3 and 4 show cutting devices 1 that differ from the cutting devices of FIGS. 1 and 2 in that the adjusting elements 20, 21, by which the connecting elements 8, 9 can be varied in length, are designed as pressure medium piston-cylinder units.

FIG. 3 shows an adjustment of the adjusting elements 20, 21, in which the distance between the first cutting blade 2 and the second cutting blade 3 is relatively large. To this end, the piston 20 of the piston-cylinder unit is moved relatively far into the cylinder 21.

FIG. 4 shows an adjustment of the adjusting elements 20, 21, in which the distance between the first cutting blade 2 and the second cutting blade 3 is relatively small compared to the adjustment shown in FIG. 3. To this end, the piston 20 of the piston-cylinder unit is moved relatively far out of the cylinder 21.

Displacement measurement and displacement control of the adjustment of the piston-cylinder unit 20, 21 can be used to achieve any desired position of the piston between completely in and completely out. A change in the course of the cut and the geometry of the cut can be realized by an asymmetrical adjustment of the two piston-cylinder units 20, 21.

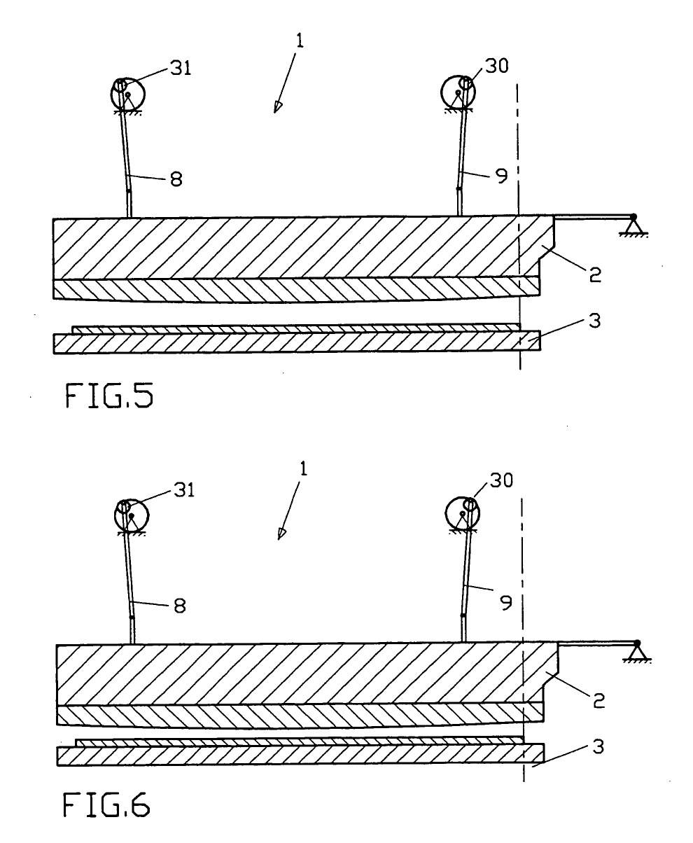

FIGS. 5 and 6 show cutting devices 1 that differ from the cutting devices of FIGS. 1, 2, 3 and 4 in that the adjusting elements 30, 31, by which the connecting elements 10, 11 can be varied in length, are designed as eccentric rings or regions, which variably form the articulation of the connecting elements 8, 9 with the eccentric shaft by virtue of the fact that the ring or the region is supported in the eccentric shaft in such a way that it can be rotated and adjusted.

FIG. 5 shows an adjustment of the adjusting elements 30, 31, in which the distance between the first cutting blade 2 and the second cutting blade 3 is relatively large. To this end, the ring is rotated in such a way that the articulation is at the top

FIG. 6 shows an adjustment of the adjusting elements 30, 31, in which the distance between the first cutting blade 2 and the second cutting blade 3 is relatively small compared to the adjustment shown in FIG. 5. To this end, the ring or region is rotated in such a way that the articulation is at the bottom. This design of an eccentric ring or region placed in the eccentric shaft or crankshaft makes it possible to produce a change in the distance of the articulation of the connecting elements 8, 9 from the axis of rotation 12, 13 of the eccentric shaft 10, 11.

### LIST OF REFERENCE NUMBERS

1 cutting device
2 cutting blade
3 cutting blade
4 cutter
5 cutter
6 blade carrier
7 blade carrier
8 connecting element
9 connecting element
10 eccentric shaft
11 eccentric shaft
12 axis
13 axis
14 adjusting element
15 adjusting element
16 adjusting element
20 adjusting element
21 adjusting element
30 adjusting element
31 adjusting element

1. A cutting device (1) with a first cutting blade (2) of an upper cutter and a second cutting blade (3) of a lower cutter and with a drive device that has at least two rotatably drivable eccentric shafts (10, 11), which are connected at least with the first cutting blade by means of connecting elements (8, 9), wherein at least one of the connecting elements (8, 9) is designed to be variably adjustable in its length.

2. A cutting device in accordance with claim 1, wherein both of the connecting elements between the eccentric shafts and the first cutting blade can be variably adjusted in length.

3. A cutting device in accordance with claim 1 or claim 2, wherein the one or more connecting elements (8, 9) have an adjusting element (14, 15, 16, 20, 21, 30, 31) for making the length adjustment of the connecting element.

4. A cutting device in accordance with claim 3, wherein the adjusting element (16) has a threaded rod or threaded spindle and at least one or preferably two threaded sleeves (14, 15).

5. A cutting device in accordance with claim 3, wherein the adjusting element has a piston-cylinder unit (20, 21) with a piston (20) and a cylinder (21).

6. A cutting device in accordance with claim 3, wherein the adjusting element (30, 31) has an eccentrically adjustable articulation on the eccentric shaft.

7. A cutting device in accordance with claim 6, wherein the eccentrically adjustable articulation on the eccentric shaft has an adjustable ring or region (30, 31), which has a rotatably variable articulation of the connecting element on the eccentric shaft (10, 11).

8. A method for controlling a cutting device (1) with a first cutting blade (2) of an upper cutter and a second cutting blade (3) of a lower cutter and with a drive device that has at least two rotatably drivable eccentric shafts (10, 11), which can be connected at least with the first cutting blade (2) by means of connecting elements (8, 9), wherein at least one of the connecting elements (8, 9) can be variably adjusted in its length.

9. A method in accordance with claim 8, wherein both connecting elements can be variably adjusted in length independently of each other.
